(19) United States
(12) Patent Application Publication
(10) Pub. No.: US 2014/0263232 A1
(43) Pub. Date: Sep. 18, 2014

(54) TANDEM HOT-WIRE SYSTEMS

(71) Applicant: LINCOLN GLOBAL, INC., City of Industry, CA (US)

(72) Inventors: Steven R. PETERS, Huntsburg, OH (US); Andrew Peters, Huntsburg, OH (US)

(21) Appl. No.: 13/836,030

(22) Filed: Mar. 15, 2013

(51) Int. Cl. B23K 9/10

(52) U.S. Cl. CPC B23K 9/1006
USPC 219/130.1

(57) ABSTRACT

A system and method is provided. In some embodiments, the system includes a first power supply that outputs a first welding current. The first power supply provides the first welding current via a torch to a first wire to create an arc between the first wire and the workpiece. The system also includes a first wire feeder that feeds the first wire to the torch, and a second wire feeder that feeds a second wire to a contact tube. The system further includes a second power supply that outputs a heating current during a first mode of operation and a second welding current during a second mode of operation. The system also includes a controller that switches the second power supply from the first mode of operation to the second mode of operation to create a second (trailing) arc.

### BACKGROUND OF THE INVENTION

1. Field of the Invention

Systems and methods of the present invention relate to welding and joining, and more specifically to tandem hot-wire systems.

2. Description of the Related Art

As advancements in welding have occurred, the demands on welding throughput have increased. Because of this, various systems have been developed to increase the speed of welding operations, including systems which use multiple welding power supplies in which one power supply is used to create an arc in a consumable electrode to form a weld puddle and a second power supply is used to heat a filler wire in the same welding operation. While these systems can increase the speed or deposition rate of a welding operation, the power supplies are limited in their function and ability to vary heat input in order to optimize the process, e.g., welding, joining, cladding, building-up, brazing, etc. Thus, improved systems are desired.

### BRIEF SUMMARY OF THE INVENTION

Exemplary embodiments of the present invention include systems and methods in which current waveforms of at least one power supply is varied to achieve a desired heat input in order to optimize a process, e.g., welding, joining, cladding, building-up, brazing, etc. In some embodiments, the system includes a first power supply that outputs a first arc welding current. The first power supply provides the first arc welding current via a torch to a first wire to create an arc between the first wire and the workpiece. The system also includes a first wire feeder that feeds the first wire to the torch, and a second wire feeder that feeds a second wire to a contact tube. The system further includes a second power supply that outputs a heating current during a first mode of operation and a second arc welding current during a second mode of operation. The second power supply provides the heating current or the second arc welding current to the second wire via the contact tube. The system also includes a controller that initiates the first mode of operation in the second power supply to heat the second wire to a desired temperature and switches the second power supply from the first mode of operation to the second mode of operation to create a second (trailing) arc. The trailing arc provides an increased heat input to the molten puddle relative to a heat input provided by the first mode of operation.

In some embodiments, The system includes a first power supply that outputs a first arc welding current during a first mode of operation and a first heating current during a second mode of operation. The first power supply provides the first arc welding current or the first heating via a first contact tube to a first wire. The system also includes a first wire feeder that feeds the first wire to the first contact tube, and a second wire feeder that feeds a second wire to a second contact tube. The system further includes a second power supply that outputs a second heating current during the first mode of operation and a second arc welding current during the second mode of operation. The second power supply provides the second heating current or the second arc welding current to the second wire via the second contact tube. The system also includes a travel mechanism that provides a relative movement between a workpiece and the first wire and the second wire such that, during a movement in a first direction, the first wire leads the second wire relative to the workpiece, and, during a movement in a second direction, the first wire trails the second wire relative to the workpiece. The system further includes a controller that initiates the first mode of operation during the first direction and automatically switches to the second mode of operation when the travel mechanism switches from the first direction to the second direction. During the first mode of operation, the first arc welding current creates an arc between the first wire and the workpiece and the second wire is heated by the second heating current to a desired temperature. During the second mode of operation, the second arc welding current creates an arc between the second wire and said workpiece and the first wire is heated by the first heating current to a desired temperature.

These and other features of the claimed invention, as well as details of illustrated embodiments thereof, will be more fully understood from the following description and drawings.

### BRIEF DESCRIPTION OF THE DRAWINGS

The above and/or other aspects of the invention will be more apparent by describing in detail exemplary embodiments of the invention with reference to the accompanying drawings, in which:

FIG. 1 is a diagrammatical representation of an exemplary embodiment of a welding system according to the present invention;

FIG. 2 is an enlarged view of the area around the torch of the system of FIG. 1;

FIGS. 3A-3C illustrate exemplary welding and hot wire waveforms that can be used in the system of FIG. 1;

FIG. 4 illustrates exemplary welding and hot waveforms that can be used in the system of FIG. 1;

FIGS. 5A and 5B illustrate an exemplary application that can be performed by the system of FIG. 1;

FIG. 6 illustrates a block diagram of an exemplary program that can be executed by the controller in the system of FIG. 1;

FIG. 7 illustrates an exemplary application that can be performed by the system of FIG. 1;

FIG. 8 illustrates a block diagram of an exemplary program that can be executed by the controller in the system of FIG. 1.

### DETAILED DESCRIPTION OF EXEMPLARY EMBODIMENTS

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

An exemplary embodiment of this is shown in FIG. 1, which shows a system 100. The system 100 illustrates an initial tandem configuration in which a first system 102 is configured as a GMAW system and a second system 104 is configured as a hot wire. As explained in detail below, in some embodiments of the present invention, the functions of one or both of these systems, and the equipment therein, can be switched between hot wire process and arc welding process as desired. For example, in some embodiments, the power supplies 130/135 can function as both arc welding power supplies and hot-wire power supplies. However, for clarity, the functions of these systems and the equipment therein are described in an exemplary initial configuration. The system 102, which can be a GMAW system, includes a power supply 130, a wire feeder 150, and a torch unit 120 that includes a contact tube 122 for welding electrode 140. The power supply 130 provides a welding waveform that creates an arc 110 between the welding electrode 140 and workpiece 115. The welding electrode 140 is delivered to a molten puddle 112 created by the arc 110 by the wire feeder 150 via the contact tube 122. Along with creating the molten puddle 112, the arc 110 transfers droplets of the welding wire 140 to the molten puddle 112. The operation of a GMAW welding system of the type described herein is well known to those skilled in the art and need not be described in detail herein. It should be noted that although a GMAW system is shown and discussed regarding depicted exemplary embodiments with respect to joining/welding applications, exemplary embodiments of the present invention can also be used with FCAW, MCAW, and SAW systems in applications involving joining/welding, cladding, building-up, brazing, and combinations of these, etc. Not shown in FIG. 1 is a shielding gas system or sub arc flux system which can be used in accordance with known methods.

The hot wire system 104 includes a wire feeder 155 feeding a wire 145 to the weld puddle 112 via contact tube 125 that is included in torch unit 120. The hot wire system 104 also includes a power supply 135 that resistance heats the wire 145 via contact tube 125 prior to the wire 145 entering the molten puddle 112. The power supply 135 heats the wire 145 to a desired temperature, e.g., to at or near a melting temperature of the wire 145. Thus, the hot wire system 104 adds an additional consumable to the molten puddle 112. The system 100 can also include a motion control subsystem that includes a motion controller 180 operatively connected to a robot 190. The motion controller 180 controls the motion of the robot 190. The robot 190 is operatively connected (e.g., mechanically secured) to the workpiece 115 to move the workpiece 115 in the direction 111 such that the torch unit 120 (with contact tubes 120 and 125) effectively travels along the workpiece 115. Of course, the system 100 can be configured such that the torch unit 120 can be moved instead of the workpiece 115.

As is generally known, arc generation systems, such as GMAW, use high levels of current to generate the arc 110 between the advancing welding consumable 140 and the molten puddle 112 on the workpiece 115. To accomplish this, many different arc welding current waveforms can be utilized, e.g., current waveforms such as constant current, pulse current, etc.

FIG. 2 depicts a closer view of an exemplary welding operation of the present invention. As can be seen contact tubes 122 and 125 are integrated into the torch unit 120 (which can be an exemplary GMAW/MIG torch). The contact tube 122 is electrically isolated from the contact tube 125 within the torch unit 120 so as to prevent current transfer between the consumables during the process. The contact tube 122 delivers a consumable 140 to the molten puddle 112 (i.e., weld puddle) through the use of the arc 110—as is generally known. Further, the hot wire consumable 145 is delivered to the molten puddle 110 by wire feeder 155 via contact tube 125. It should be noted that although the contact tubes 120/125 are shown in a single integrated unit, these components can be separate.

As illustrated in FIG. 1, a sensing and current controller 195 can be used to control the operation of the power supplies 130 and 135 to control/synchronize the respective currents. In addition, the sensing and current controller 195 can also be used to control wire feeders 150 and 155. In FIG. 1, the sensing and current controller 195 is shown external to the power supplies 130 and 135, but in some embodiments the sensing and current controller 195 can be internal to at least one of the welding power supplies 130 and 135 or to at least one of the wire feeders 150 and 155. For example, at least one of the power supplies 130 and 135 can be a master which controls the operation of the other power supplies and the wire feeders. During operation, the sensing and current controller 195 (which can be any type of CPU, welding controller, or the like) controls the output of the welding power supplies 130 and 135 and the wire feeders 150 and 155. This can be accomplished in a number of ways. For example, the sensing and current controller 195 can use real-time feedback data, e.g., arc voltage V₁, welding current I₁, heating current I₂, sensing voltage V₂, etc., from the power supplies to ensure that the welding waveform and heating current waveform from the respective power supplies are properly synced. Further, the sensing and current controller 195 can control and receive real-time feedback data, e.g., wire feed speed, etc., from the wire feeders 150 and 155. Alternatively a master-slave relationship can also be utilized where one of the power supplies is used to control the output of the other.

The control of the power supplies and wire feeders can be accomplished by a number of methodologies including the use of state tables or algorithms that control the power supplies such that their output currents are synchronized for a stable operation. For example, the sensing and current controller 195 can include a parallel state-based controller. Parallel state-based controllers are discussed in application Ser. Nos. 13/534,119 and 13/438,703, which are incorporated by reference herein in their entirety. Accordingly, parallel state-based controllers will not be further discussed in detail.

FIGS. 3A-C depicts exemplary current waveforms for the arc welding current and the hot wire current that can be output from power supplies 130 and 135, respectively. FIG. 3A depicts an exemplary arc welding waveform 201 (e.g., GMAW waveform) which uses current pulses 202 to aid in the transfer of droplets from the wire 140 to the puddle 112 via the arc 110. Of course, the arc welding waveform shown is exemplary and representative and not intended to be limiting, for example the arc welding current waveform can be that used for pulsed spray transfer, pulse welding, short arc transfer, surface tension transfer (STT) welding, shorted retract welding, etc. The hot wire power supply 135 outputs a current waveform 203 which also has a series of pulses 204 to heat the wire 145, through resistance heating as generally described above. The current pulses 202 and 204 are separated by a background levels 210 and 211, respectively, of a lesser current level than their respective pulses 202 and 204. As generally described previously, the waveform 203 is used to heat the wire 145 to a desired temperature, e.g., to at or near its melting temperature and uses the pulses 204 and background to heat the wire 145 through resistance heating. As shown in FIG. 3A the pulses 202 and 204 from the respective current waveforms are synchronized such that they are in phase with each other. In this exemplary embodiment, the current waveforms are controlled such that the current pulses 202/204 have a similar, or the same, frequency and are in phase with each other as shown. As discussed above, the effect of pulsing pulses 202 and 204 at the same time, i.e., in phase, is to pull the arc 110 toward the wire 145 and further over the weld puddle 112. Surprisingly, it was discovered that having the waveforms in phase produces a stable and consistent operation, where the arc 110 is not significantly interfered with by the heating current generated by the waveform 203.

FIG. 3B depicts waveforms from another exemplary embodiment of the present invention. In this embodiment, the heating current waveform 205 is controlled/synchronized such that the pulses 206 are out-of-phase with the pulses 202 by a constant phase angle Θ. In such an embodiment, the phase angle is chosen to ensure stable operation of the process and to ensure that the arc is maintained in a stable condition. In exemplary embodiments of the present invention, the phase angle Θ is in the range of 30 to 90 degrees. In other exemplary embodiments, the phase angle is 0 degrees. Of course, other phase angles can be utilized so as to obtain stable operation, and can be in the range of 90 to 270 degrees, while in other exemplary embodiments the phase angle is in the range of 0 and 180 degrees.

FIG. 3C depicts another exemplary embodiment of the present invention, where the hot wire current 207 is synchronized with the arc welding waveform 201 such that the hot wire pulses 208 are out-of phase such that the phase angle Θ is about 180 degrees with the welding pulses 202, and occurring only during the background portion 210 of the waveform 201. In this embodiment the respective currents are not peaking at the same time. That is, the pulses 208 of the waveform 207 begin and end during the respective background portions 210 of the waveform 201.

FIG. 4 depicts another exemplary embodiment of current waveforms of the present invention. In this embodiment, the hot wire current 403 is an AC current, which is synchronized with the welding current 401 (e.g. a GMAW system). In this embodiment, the positive pulses 404 of the heating current are synchronized with the pulses 402 of the current 401, while the negative pulses 405 of the heating current 403 are synchronized with the background portions 406 of the arc welding current. Of course, in other embodiments the synchronization can be opposite, in that the positive pulses 404 are synchronized with the background 406 and the negative pulses 405 are synchronized with the pulses 402. In another embodiment, there is a phase angle between the pulsed welding current and the hot wire current. By utilizing an AC waveform 403 the alternating current (and thus alternating magnetic field) can be used to aid in stabilizing the arc 110. Of course, other embodiments can be utilized without departing from the spirit or scope of the present invention.

In some embodiments of the present invention, the arc welding current can be a constant or near constant current waveform. In such embodiments, an alternating heating current 403 can be used to maintain the stability of the arc. The stability is achieved by the constantly changed magnetic field from the heating current 403. It should be noted that although FIGS. 3A-3C and 4 depict the exemplary waveforms as DC welding waveforms, the present invention is not limited in this regard as the pulse waveforms can also be AC. Additional information and systems related to tandem hot wire welding may be found in co-pending application Ser. No. 13/547,649, which is incorporated by reference herein in its entirety.

In some exemplary embodiments of the present invention, the pulse width of the welding and hot-wire pulses is the same. However, in other embodiments, the respective pulse-widths can be different. For example, when using a GMAW pulse waveform with a hot wire pulse waveform, the GMAW pulse width is in the range of 1.5 to 2.5 milliseconds and the hot-wire pulse width is in the range of 1.8 to 3 milliseconds, and the hot wire pulse width is larger than that of the GMAW pulse width.

It should be noted that although the heating current in the exemplary embodiments is shown as a pulsed current, for some exemplary embodiments the heating current can be constant power. The hot wire current can also be a pulsed heating power, constant voltage, a sloped output and/or a joules/time based output.

As explained herein, to the extent both currents are pulsed currents, they should to be synchronized to ensure stable operation. There are many methods that can be used to accomplish this, including the use of synchronization signals. For example, the sensing and current controller 195 (which can, e.g., be integral to either or the power supplies 135/130) can set a synchronization signal to start the pulsed arc peak in a first power supply and also set the desired start time for the hot wire pulse peak (and/or a second arc pulse in some embodiments) in a second power supply. As explained above, in some embodiments, the pulses will be synchronized to start at the same time, while in other embodiments the synchronization signal can set the start of the pulse peak for the hot wire current (and/or a second arc pulse) at some duration after the arc pulse peak of the first power supply—the duration would be sufficient to obtained the desired phase angle for the operation.

In the embodiments discussed above, the arc 110 is positioned in the lead—relative to the travel direction. This is shown in each of FIGS. 1 and 2. This is because the arc 110 is used to achieve the desired penetration in the workpiece(s). That is, the arc 110 is used to create the molten puddle 112 and achieve the desired penetration in the workpiece(s). Then, following behind the first arc process is the hot wire process (and/or a second arc process). The addition of the hot wire process adds more consumable 145 to the puddle 112 without the additional heat input of another welding arc, such as in a traditional tandem MIG process in which at least two arcs are used. However, in some embodiments, a second arc process can be desirable for a limited time period from wire 145. With either configuration, embodiments of the present invention can achieve significant deposition rates at considerably less heat input than known tandem welding methods.

As shown in FIG. 2, the hot wire 145 is inserted in the same weld puddle 112 as the arc 110, but trails behind the arc by a distance D. In some exemplary embodiments, this distance is in the range of 5 to 20 mm, and in other embodiments, this distance is in the range of 5 to 10 mm. Of course, other distances can be used so long as the wire 145 is fed into the same molten puddle 112 as that created by the leading arc 110. However, the wires 140 and 145 are to be deposited in the same molten puddle 112 and the distance D is to be such that there is minimal adverse magnetic interference with the arc 110 by the heating current used to heat the wire 145 (or a second arc as in some embodiments). In general, the size of the puddle 112—into which the arc 110 and the wire 145 are collectively directed—will depend on the welding speed, arc parameters, total power to the wire 145, material type, etc., which will also be factors in determining a desired distance between wires 140 and 145.

As stated above, because at least two consumables 140/145 are used in the same puddle 112 a very high deposition rate can be achieved, with a heat input decrease of up to 35% based on a comparable tandem system during most welding modes of operation. This provides significant advantages over full-time tandem MIG welding systems which have very high heat input into the workpiece. For example, embodiments of the present invention can easily achieve at least 23 lb/hr deposition rate with the heat input of a single arc. Other exemplary embodiments have a deposition rate of at least 35 lb/hr.

In exemplary embodiments of the present invention, each of the wires 140 and 145 are the same, in that they have the same composition, diameter, etc. However, in other exemplary embodiments the wires can be different. For example, the wires can have different diameters, wire feed speeds and composition as desired for the particular operation. In an exemplary embodiment the wire feed speed for the lead wire 140 is higher than that for the hot wire 145. For example, the lead wire 140 can have a wire feed speed of 450 ipm, while the trail wire 145 has a wire feed speed of 400 ipm. Further, the wires can have different size and compositions.

In some exemplary embodiments of the present invention, the combination of the arc 110 and the hot-wire 145 (or a second arc from wire 145) can be used to balance the heat input to the weld deposit, consistent with the requirements and limitations of the specific operation to be performed. For example, the heat from the lead arc 110 can be increased (or a second arc from wire 145 used as needed) for joining applications where the heat from the arc (or arcs) aids in obtaining the penetration needed to join the work pieces and the hot-wire 145, when not used in an arc mode, is primarily used for fill of the joint. In cladding or build-up processes, the hot-wire wire feed speed can be increased to minimize dilution and increase build up.

Further, because different wire chemistries can be used, a weld joint can be created having different layers, which is traditionally achieved by two separate passes. The lead wire 140 can have the required chemistry needed for a traditional first pass, while the trail wire 145 can have the chemistry needed for a traditional second pass. Further, in some embodiments at least one of the wires 140/145 can be a cored wire. For example the hot wire 145 can be a cored wire having a powder core which deposits a desired material into the weld puddle.

In the above embodiments, system 102 and its components, e.g., power supply 130, was described as an arc welding system and system 104 and its components, e.g., power supply 135, was described primarily as a hot wire system. However, in some embodiments, the functions of these systems can be switched. That is, system 104 can function as an arc welding system and system 102 can function as a hot wire system. In such embodiments, the description herein of system 102 as it relates to an arc welding system is applicable to system 104 when system 104 is in the welding mode, and the description herein of system 104 as it relates to a hot wire system is applicable to system 102 when system 102 is in the hot wire mode.

As discussed above, the hot wire/GMAW tandem process allows for deposit rates equal to that of a full-time tandem GMAW operation, but with a heat input closer to that of a single arc process. Because of the lower heat input, the hot wire/GMAW tandem process is a low penetration process. Often, when a low penetration process abuts a previous pass or other protrusion in the substrate, the weld metal will bridge the joint, which leaves a void. To avoid this, the torch can be held over the joint area of concern in order to increase the heat input to the joint area. However, this increases the time required to perform the process, e.g., joining, cladding, etc., which is inefficient

In exemplary embodiments of the present invention, the increased penetration is done “on the fly” by increasing the heat input from the power supply performing the hot wire operation. In the exemplary embodiment of FIG. 1, the power supply 135 of system 100 outputs a heating current waveform to the wire 145, e.g., the heating current waveform can be one of waveforms 203, 205, 207, or 403 discussed above or another waveform. When the torch unit 120 travels over an area that requires higher heat input than that provided by the combination of the arc 110 and the hot wire 145, the sensing and current controller 195 (or some other device) can switch the operation of power supply 135 from that of heating the wire 145 to an arc welding operation, i.e., adding a second arc by switching the output of power supply 135 from a heating current to an arc welding current. For example, the arc welding current can be a high-heat input process such as pulse spray transfer or a relatively lower heat input process such as short arc transfer, surface tension transfer (STT) welding, shorted retract welding, etc. It should be noted that while the short arc processes (short arc transfer, STT, shorted retract welding) are a lower heat input relative to the pulse spray process, the short arc processes still provide greater heat input than the hot wire process. In addition (or in the alternative), the wire feed speed can be increased to focus the heat input.

By changing from a heating current to an arc welding current “on-the-fly,” the process (e.g., cladding, joining, etc.) is not slowed down in the exemplary embodiments of the present invention. The joint or cladding areas that need additional heat input can be identified ahead of time and input to the controller 195 so that the controller 195 can automatically switch the function of the power supply 135 from a heating operation to an arc welding operation as needed. For example, FIG. 5A illustrates a weld joint 510 created by workpieces 115A and 115B. The system 100 is configured such that the torch unit 120 weaves a pattern P from one sidewall 515A of the weld joint 510 to the other sidewall 515B (see I, II and III) as the torch unit 120 travels along the weld joint 510 (see arrow). The weaving action P can be performed by the robot 190 (see FIG. 1) or a mechanical oscillator (not shown) as is known in the art.

In this exemplary embodiment, as illustrated in FIG. 5B, the welding joint 510 requires high heat input at the sidewalls 515A, 515B for proper fusion with the sidewalls 515A, 515B. However, once the torch unit 120 moves away form the sidewalls, the heat input provided by a hot wire/GMAW tandem is sufficient for a proper weld. As such, the system 100 is configured so that the power supply 135 outputs a heating current to wire 145 when the torch unit 120 has moved away from the sidewalls 515A and 515B, and an arc welding current when the torch unit 120 is at a sidewall 515A, 515B. When the power supply 135 is outputting an arc welding current, the torch unit 120 outputs two arcs, as the arc welding current of power supply 135 will create a second arc between wire 145 and workpieces 115A,115B. In some embodiments of the present invention, the torch unit 120 can remain at the sidewalls 515A, 515B for a predetermined duration in order to ensure that there is proper fusion at the sidewalls 515A, 515B. The duration can be based on, e.g., a predetermined weld time t_{w} or on a predetermined weld cycle count c_{w}, e.g., a peak pulse count, of the welding waveform.

The sensing and current controller 195, robot 190, and/or the mechanical oscillator can be preconfigured such that the switching of power supply 135 from/to the welding current occurs at the proper time, i.e., when the torch unit 120 is at the sidewalls 515A, 515B. For example, in some embodiments, the timing of the weave pattern P (or the weld joint 510 dimensions) can be preconfigured in the mechanical oscillator or the robot 190 and the system 100 can be calibrated such that it is known when the torch unit 120 will be at the sidewalls 515A, 515B based on the weave pattern. The mechanical oscillator or the robot 190 can then send a signal to the sensing and current controller 195 that the torch unit 120 is at a sidewall 515A, 515B (or away from the sidewall 515A, 515B) so that the controller 195 can take the appropriate action. In other embodiments, rather than a signal from the robot 190 or mechanical oscillator, the sensing and current controller 195 can be set up such that the heating current is output for a predetermined heating time period t_{H} (or a predetermined heating current cycle count c_{H}, e.g., number of peak pulses) before switching to the welding current for a predetermined time t_{w} or cycle count c_{w}. The timing of controller 195 is then synchronized with the weave pattern from robot 190 or the mechanical oscillator. In still other embodiments, the controller 195 can be configured to sense the sidewalls 515A, 515B, e.g., by using the arc voltage V₁ or some other feedback input.

FIG. 6 illustrates an exemplary program 600 that can be implemented by the sensing and current controller 195 (or some other device) to control the output of the power supply 135 to perform the switching between the welding process 602 and the heating process 604. Prior to staring the process, the initial configuration is input to controller 195 so that the controller 195 can then start processing program 600 at the appropriate process 602 or 604. For example, the controller 195 can be configured to initiate the process with torch unit 120 positioned at a sidewall 515A or 515B. Of course the process can be initiated with the torch 120 in another position in the weld joint 510. When the torch unit 120 is at a sidewall, the power supply 135 will need to output an arc welding current signal in order get the proper heat input for this process. The position of the torch unit 120 is monitored by a travel position process 606, e.g., from signals received from the robot 190 and/or mechanical oscillator or some other device. If the torch unit 120 is at a side wall, then the travel position process 606 will initiate step 607 which sends a signal to start the arc welding process 602 (see step 603A) and stop the heating process 604 (see step 605B). Once the arc welding process 602 has started, the controller 195 will go to step 610 and check for the synchronization pulse that indicates that the power supply 130 has initiated an arc welding current peak pulse, e.g., a peak pulse 202 (see FIG. 3), for its arc welding process. Of course, another portion of the arc welding current waveform of power supply 130 can be used for synchronization purposes such as, e.g., the falling edge of the peak pulse, etc. Once the synchronization signal is received, the controller 195 goes to step 615 and waits an appropriate time based on the desired phase angle Θ before initiating an arc welding current pulse from power supply 135 at step 620. In some embodiments, based on the type of arc welding and heating current waveforms, the synchronization signal may not be needed. After holding the peak welding current level for a predetermined period of time at step 622 and incrementing a counter C by one, the arc welding current from power supply 135 is ramped down to a background current level at step 624. At step 626, the background level is held for a predetermined duration before going to step 630 where the counter C is checked to see if it is less than a predetermined count c_{w}. If so, the controller 195 goes back to step 620 where the next arc welding peak pulse from power supply 135 is initiated. If the count C is greater than or equal to c_{w}, the controller 195 starts the heating current process 604 (see step 605A). Of course, if the torch unit 120 should reach the end of travel at any time during the arc welding process 602, which is monitored by the travel position process 606 at step 608, the controller will immediately stop the arc welding process 602 (see step 603B). It should be noted that the arc welding phase of the power supply 135 can be any desired duration. For example, the arc welding current can be output from the power supply 135 the entire time the torch unit 120 is at a sidewall 515A, 515B or just a portion of the time. In addition, the arc welding current from the power supply 135 can be initiated prior to the torch unit 120 reaching a sidewall and/or be extended for a time period after the torch unit 120 has moved away from the sidewall. In addition, instead of a predetermined number of cycles c_{w}, the duration of the arc welding current process 602 from the power supply 135 can be based on a predetermined time period t_{w}, i.e., in step 630 the controller 135 can check a timer rather than the counter C.

When the controller starts the heating process 604 at step 605A, the arc suppression monitor routine 660 monitors the voltage V₂ (see FIG. 1). During the arc welding process 602, the voltage V₂ of the power supply 135 is a range of 14 to 40 volts. When the wire 145 is shorted and the power supply 135 is outputting heating current, the operating current level is similar to the arc welding mode, but the voltage V₂ is 1 to 12 volts because the system does not include the cathode/anode drop. Thus, a voltage of 13 volts or more can mean that the arc has not extinguished. Accordingly, based on a predetermined voltage V_{H}, which can be set at, e.g., 13 volts, the arc suppression routine 660 will determine whether to stop the power supply 135 and let the wire 145 short to the weld puddle 112 or start the heating current cycle by going to step 640. If the voltage V_{H} is greater then or equal to 13 volts, the power supply 135 is stopped until the wire 145 has shorted to puddle 112 based on, e.g., timer or a sensing mechanism such as a torque sensor in wire feeder 155. Of course other values for V_{H} can be used based on the system and/or process. Once the voltage V_{H} is below voltage V_{H}, the controller goes to step 640. However, even during the heating current cycle, the arc suppression routine 660 monitors the voltage V₂ and stops the power supply 135 to suppress the arc on the wire 145 if the voltage V₂ is above V_{H}.

At step 640, the controller 195 waits for the synchronization signal indicating that the power supply 130 has initiated an arc welding current peak pulse, e.g., a peak pulse 202. As before, another portion of the arc welding current waveform of the power supply 130 can be used for synchronization purposes such as, e.g., the falling edge of the peak pulse, etc. Once the synchronization signal has been received, the controller 195 waits an appropriate time based on the desired phase angle Θ before initiating a heating current pulse at step 650, e.g., the heating current pulse can be pulse 204, 206, or 208 as shown in FIG. 3. In some embodiments, based on the type of welding and heating current waveforms, the synchronization signal may not be needed.

After holding the peak heating current level for a predetermined period of time at step 652, the heating current from power supply 135 is ramped down to a background current level at step 654. At step 656, the background heating current level is held for a predetermined period of time before the controller 195 goes to step 650 and a new heating current cycle is started. The heating current cycle continues until the cycle is stopped at step 605B because either the torch unit 120 is at a sidewall 515A, 515B (step 607) or the torch unit 120 has reached the end of travel (step 608).

In the above program 600, it is assumed that robot 190 and/or a mechanical oscillator is providing the sidewall position and the end of travel signals. However, other signals that indicate the proximity of torch unit 120 to the sidewall 515A and/or sidewall 515B can be used to the initiate welding current process 602 and/or the heating current process 604. For example, a signal based on the arc voltage V₁ can be used to indicate when the torch unit 120 is near a sidewall 515A, 515B, or similar to the arc welding process 602, the system can be synchronized to the heating current waveform and the processes can be switched based whether a predetermined time period t_{H} or a predetermined cycle count c_{H}, e.g., the number of peak heating current pulses, has been met. In addition, the heating current process 604 in the above exemplary embodiment is DC, but the present invention is not so limited and a variable polarity heating current, e.g., waveform 403 of FIG. 4, can be used with the appropriate modifications to the program steps of heating current process 604. Further, the exemplary embodiments discussed above use pulse type waveforms for the arc welding current process 602 and the heating current process 604. However, the present invention can use any type of welding current as long as it provides a higher heat input than a hot wire heating current, and any type of heating current. For example, the arc welding and heating waveforms can be sinusoidal, triangular, soft-square wave, etc. Also, in the embodiments discussed above, the heating current waveform stayed the same during the process. However, in some embodiments of present invention, the heating current shape or type, amplitude, zero offset, pulse widths, phase angles, or other parameters of the heating current can be changed as desired to control heat input. Similarly, the arc welding current shape or type, amplitude, zero offset, pulse widths, phase angles, or other parameters of the heating current can be changed as desired to control heat input. For example, the arc welding current process 602 can include changing between a high heat input welding process such as, e.g., a pulse spray process, and a relatively lower heat input welding process, e.g., short arc transfer, STT, shorted retract welding, etc., as desired to optimize the process, e.g., joining, cladding, etc.

In addition, while the exemplary embodiments discussed above relate to controlling heat input for a joining-type application, and more specifically, to increasing heat input at the sidewalls of a weld joint, the present invention is not so limited. The present invention can be used to control heat input in other applications such as, e.g., cladding applications in which a higher heat input is needed to joint to the edge of a cladding layer that was deposited in a previous pass. In addition, controlling of the heat input need not be limited to applications concerning sidewalls and weld/cladding edges. For example, the sensing and current controller 195 (or some other device) can switch from the hot wire heating current process to an arc welding current process in order to maintain the weld puddle 112 temperature at a desired value. For example, the weld puddle 112 temperature can be an input to the controller 195 from sensor 117 (see FIG. 1). Based on the feedback from sensor 117, the controller 195 can maintain the weld puddle 112 temperature (or an area adjacent to the weld puddle 112) at a desired value as discussed above. The sensor 117 can be a type that uses a laser or infrared beam, which is capable of detecting the temperature of a small area—such as the weld puddle 112 or an area around weld puddle 112—without contacting the weld puddle 112 or the workpiece 115. Of course, other methods can be used to control the switch from a hot wire heating current process to a welding current process such as, e.g., a time-based switching operation (switching every few ms) or a distance-based switching operation (switching every few cm) in order to control the heat input to the process.

In the above exemplary embodiments, the power supply controlling the heating current was switched to a welding current process based on a desired heat input. However, the present invention is not limited to just regulating the heat input by changing the function of a hot wire power supply. In some embodiments, the functions of the welding power supply and the hot wire power supply can be switched to optimize the process. For example, as discussed above, the arc leads the hot wire in the exemplary hot wire tandem applications (see FIG. 2). In conventional systems, the power supplies are not capable of switching functions. That is, the welding power supply can only output a welding current waveform and the hot wire power supply can only output a heating current waveform. Thus, the direction of travel with respect to the torch 120 is not reversible in conventional system. For example, in FIG. 2, the operation goes from right to left with the arc 110 in the lead and the hot wire 145 training. For the system to continue operation after completing its pass, either the torch unit 120 has to be repositioned to the far left again for the next pass or the orientation of the torch unit 120 with respect to the torch (arc) and the hot wire must be physically reversed to go from left to right. Either approach means that valuable time is lost, which makes the process inefficient.

In some embodiments of the present invention, the arc and hot wire functions can be switched “on-the-fly” for the respective power supplies 130 and 135 without the having to physically reverse the configuration of torch unit 120 or reposition the system. FIG. 7 illustrates a cladding operation in which strips of cladding are deposited adjacent to one another. The cladding operation can be performed, e.g., by the system illustrated in FIG. 1. The offset from one pass to the next can automatically be set by the robot 190 (or some other mechanical device) or done manually by an operator. For each pass, the torch unit 120 can be oscillated in a weave pattern similar to that described above (see FIG. 5A) by the robot 190 (or a mechanical oscillator). As illustrated in FIG. 7, the system has completed a first pass 701 in direction 702 and is performing a second pass 703 in direction 704. In the first pass 701, the wire 140 was the lead wire (arc). Thus, the sensing and current controller 195 (or some other device) controlled the power supply 130 to output the arc welding current to the wire 140 during the first pass 701. For example, the arc welding current waveform can be one of waveforms in FIGS. 3A-3C and 4 (or another welding waveform). Also during the first pass 701, the wire 145, which was trailing the wire 140, was the hot wire and the controller 195 controlled power supply 135 to output a heating current waveform to the wire 145, e.g., one of the hot wire current waveforms in FIGS. 3A-3C and 4 (or another heating current waveform).

In the second pass 703, the wire 145 becomes the lead wire. At this time, the controller 195 automatically (i.e., “on-the-fly”) switches the operation of the power supply 135 from a heating current process to an arc welding current process such that the power supply 135 outputs a welding current waveform, e.g., one of welding current waveforms in FIGS. 3A-3C and 4 (or another welding waveform). Typically, but not necessarily, the welding current waveform will be the same as that used by power supply 130 in the first process. Conversely, because the wire 140 is now the trailing wire, it will act as the hot wire and the controller 195 will automatically switch the output of the power supply 130 from an arc welding current waveform to a heating current waveform. Thus, during the second pass, the power supply 130 will output a heating current waveform, e.g., one of hot wire current waveforms in FIGS. 3A-3C and 4 (or another heating current waveform). Typically, but not necessarily, the heating current waveform will be the same as that used by the power supply 135 in the first process. Thus, based on the direction of travel, the controller 195 will automatically switch the operations of the power supplies 130, 135. In addition, in some exemplary embodiments, the system can switch from tandem arc to one arc/hot wire process based on the needs of the joint. For example, if the joint is narrow, a tandem arc process can be desirable. However, for an area where there is a large gap, it can be desirable to switch to a combination of arc and hot wire. As in the above embodiments, the switch can occur “on-the-fly” based on the needs of the joint.

FIG. 8 illustrates an exemplary program 800 that can be implemented in the sensing and current controller 195 for controlling power supplies 130 and 135. Of course, the programming can be located in either one of power supplies 130 and 135 (or some other device). The program 800 is directed to hot wire tandem processes that have multiple passes in which the arc and hot wire initially travel on one direction for one pass and then the opposite direction for the next pass. For example, the program 800 can be directed to a multi-pass cladding operation such as that illustrated in FIG. 7 or a joining operation such as that illustrated in FIG. 5B. As illustrated in FIG. 8, the program 800 receives the initial direction of travel signal 804 of the torch and hot wire. The initial direction of travel signal 804 can be an input by the operator or automatically determined by, e.g., robot 190, based on the initial configuration of the system. The direction of travel signal 804 is checked by the controller 195 at step 802. Based on the direction of travel, the controller determines which of the wires is the lead wire (arc) and which is the trail wire (hot wire). For example, for the right to left direction of FIG. 2, the wire 140 is the lead (arc) and the wire 145 is the trail (hot wire). Thus, for a travel signal 804 that corresponds to the wire 140 being the lead, the program 800 goes to step 810 where, in step 810A, the power supply 130 is controlled to output a welding process. For example, step 810A can initiate a program that outputs the welding current 201 of FIG. 3 or the welding current 401 of FIG. 4. Of course, the welding process is not limited to the exemplary embodiments of FIGS. 3 and 4 and can be any desired welding process such as pulse spray transfer, short arc transfer, STT, shorted retract welding, etc. In addition, step 810A can initiate a program that can switch welding processes as desired, e.g., switching from pulse spray transfer to short arc transfer in order to control heat input or for some other reason. In step 810B, the power supply 135 is controlled to output a heating current process. For example, step 810B can initiate a program that outputs the heating current 203, 205, or 207 of FIGS. 3A to 3C, respectively, or the heating current 403 of FIG. 4. Of course, the heating process is not limited to the exemplary embodiments in FIGS. 3 and 4 and can be any desired heating process that heats the hot wire to a desired temperature. In addition, step 810B can initiate a program that switches between an arc welding process and a heating process in order to control the heat input or for some other reason. For example, the step 810B can initiate a program that is similar to the program 600 of FIG. 6 in order to ensure proper fusion with, e.g., a previously deposited weld/cladding layer, a weld joint sidewall, etc. Of course, appropriate modifications may need to be made to program 600 in order to take into account the different requirements for the different processes, e.g., requirements of cladding vs. joining, etc. For example, the travel position process 606 can be programmed such that it will only send the “at sidewall” signal when the torch unit 120 is at the side adjacent to the previous cladding pass.

Once the controller 195 initiates the appropriate process in step 810, the controller 195 checks for a signal 806 that the system has completed a pass (weld, cladding, building-up, etc.), e.g., cladding pass 702 or 704 as illustrated in FIG. 7. The end of pass signal 806 can be initiated manually or automatically by the system (e.g., controller 195, robot 190, etc.) based on, e.g., an initial configuration of the system, appropriate sensors, etc. If the signal 806 is not present, the controller 195 will continue the arc welding process (step 810A) and the heating process (step 810B) of step 810. If the end of pass signal 806 is present, then in step 814, the controller 195 will check for a signal 808 to see if the process should stop. The end of process signal 808 can be initiated manually or automatically by the system (e.g., controller 195, robot 190, etc.) based on, e.g., an initial configuration of the system, appropriate sensors, etc. For example, the controller 195 (or some other device) may be configured with the number of passes that is required for a particular process. One the system reaches the configured number of passes, the end of process signal 808 is sent to program 800. Of course, alternatively (or in addition to) and similar to the “End of Travel” signal 608, the “Check for End of Process” step 814 can be programmed such that it will stop the process at any time if the torch unit 120 has reached the end of travel.

If the end of process signal 808 is not present, the controller 195 will automatically switch the functions of system 102 and 104 for the next pass, which is in the opposite direction of travel. For example, in our exemplary embodiment, the system will travel such that the wire 145 is in the lead (arc) and wire 140 is trailing (hot wire). Thus, the program 800 goes to step 820 where, in step 820A, the power supply 130 is controlled to output a heating process, and in step 82B, the power supply 135 is controlled to output an arc welding process. The functions in steps 820 to 822 are similar the functions in steps 810 to 812, respectively, except that power supply 135 will output the arc welding process and power supply 130 will output the heating process (or a modified heating/arc welding process). Therefore, these functions in these steps will not be further discussed. If the end of process signal 808 is not present in step 824, the controller will repeat steps 810 to 814 (i.e., the next pass). The controller 195 will then switch between steps 810-814 and steps 820-824 for each subsequent pass until the end of process signal 808 is present. If signal 808 is present, the process stops (see step 830).

It should be noted that although a GMAW system is shown and discussed regarding depicted exemplary embodiments with DC and variable polarity hot wire current waveforms, exemplary embodiments of the present invention can also be used with FCAW, MCAW, and SAW systems in applications involving joining/welding, cladding, brazing, and combinations of these, etc.

While the invention has been particularly shown and described with reference to exemplary embodiments thereof, the invention is not limited to these embodiments. It will be understood by those of ordinary skill in the art that various changes in form and details may be made therein without departing from the spirit and scope of the invention as defined by the following claims.

1. A welding system, said system comprising
a joint created by an alignment of a first workpiece and a second workpiece;
a torch;
a first power supply that outputs a first welding current, said first power supply providing said first welding current via said torch to a first wire to create a lead arc between said first wire and said joint, said lead arc creating a molten puddle in said joint;
a first wire feeder that feeds said first wire to said torch;
a second wire feeder that feeds a second wire to a contact tube;
a second power supply that outputs a heating current during a first mode of operation and a second welding current during a second mode of operation, said second power supply providing said heating current or said second welding current to said second wire via said contact tube;
a travel mechanism that provides a relative movement between said joint and said first wire and said second wire such that said first wire and said second wire move between a first sidewall of said joint and a second sidewall of said joint in a weave pattern; and
a controller that initiates said first mode of operation in said second power supply to heat said second wire to a desired temperature and switches said second power supply from said first mode of operation to said second mode of operation to create a trailing arc, said trailing arc created between said second wire and said joint,
wherein said trailing arc provides an increased heat input to said molten puddle relative to a heat input provided by said first mode of operation when said first wire and said second wire are at at least one of said first sidewall and said second sidewall.

2. The system of claim 1, wherein said desired temperature is at or near a melting temperature of said second wire.

3. The system of claim 1, wherein a timing of said controller is synchronized to said wave pattern of said travel mechanism to determine when said torch is at said at least one of said first sidewall and said second sidewall.

4. The system of claim 1, wherein said controller senses when said torch is at said at least one of said first sidewall and said second sidewall based on an arc voltage of said lead arc.

5. The system of claim 1, wherein said torch is at said at least one of said first sidewall and said second sidewall for a predetermined duration.

6. The system of claim 4, wherein said predetermined duration is based on a weld time or a weld cycle count.

7. The system of claim 1, wherein said second welding current is a welding current correspond to a pulse spray transfer process, a surface tension transfer process, or a shorted retract welding process.

8. The system of claim 7, wherein said controller switches said second welding current between any of said pulse spray transfer process, said surface tension transfer process, and said shorted retract welding process in order to control heat input.

9. The system of claim 1, wherein said first welding current and at least one of said second welding current and said heating current are synchronized, and
wherein at least one of said second welding current and said heating current is shifted by a desired phase angle from said first welding current.

10. The system of claim 1, wherein said controller maintains said molten puddle at a desired temperature based on one of a feedback from a temperature sensor, time-based switching operations, or distance-based switching operations.

11. A method of welding, said method comprising:
creating a joint by aligning a first workpiece and a second workpiece;
providing a first welding current to a first wire via a torch to create a lead arc between said first wire and said joint, said lead arc creating a molten puddle in said joint;
feeding said first wire to said torch;
feeding a second wire to a contact tube;
providing a heating current to said second wire via said contact tube during a first mode of operation;
providing a second welding current to said second wire via said contact tube during a second mode of operation;
providing a relative movement between said joint and said first wire and said second wire such that said first wire and said second wire move between a first sidewall of said joint and a second sidewall of said joint in a weave pattern;
initiating said first mode of operation to heat said second wire to a desired temperature; and
switching from said first mode of operation to said second mode of operation to create a trailing arc, said trailing arc created between said second wire and said joint,
wherein said trailing arc provides an increased heat input to said molten puddle relative to a heat input provided by said first mode of operation when said first wire and said second wire are at at least one of said first sidewall and said second sidewall.

12. The method of claim 11, wherein said desired temperature is at or near a melting temperature of said second wire.

13. The method of claim 11, further comprising:
synchronizing a timing of said controller to said weave pattern of said travel mechanism to determine when said torch is at said at least one of said first sidewall and said second sidewall.

14. The method of claim 11, further comprising:
sensing when said torch is at said at least one of said first sidewall and said second sidewall based on an arc voltage of said lead arc.

15. The method of claim 11, further comprising:
keeping said torch at said at least one of said first sidewall and said second sidewall for a predetermined duration.

16. The method of claim 15, wherein said predetermined duration is based on a weld time or a weld cycle count.

17. The method of claim 11, wherein said second welding current is a welding current corresponding to a pulse spray transfer process, a surface tension transfer process, or a shorted retract welding process.

18. The method of claim 17, further comprising:
switching said second welding current between any of said pulse spray transfer process, said surface tension transfer process, and said shorted retract welding process in order to control heat input.

19. The system of claim 1, further comprising:
synchronizing said first welding current and at least one of said second welding current and said heating current; and
shifting at least one of said second welding current and said heating current from said first welding current by a desired phase angle.

20. The system of claim 1, further comprising:
maintain said molten puddle at a desired temperature based on one of a feedback from a temperature sensor, time-based switching operations, or distance-based switching operations.
